(19) United States
(12) Patent Application Publication
(10) Pub. No.: US 2026/0010999 A1
(43) Pub. Date: Jan. 8, 2026

(54) SUBSTRATE PROCESSING SYSTEM

(71) Applicant: Tokyo Electron Limited, Tokyo (JP)

(72) Inventors: Daiki MORIMOTO, Koshi City (JP); Tatsuya NAGAMATSU, Koshi City (JP)

(21) Appl. No.: 19/250,143

(22) Filed: Jun. 26, 2025

(30) Foreign Application Priority Data
Jul. 8, 2024 (JP) 2024-109799

(51) Int. Cl. G06T 7/00; B08B 3/04; B08B 13/00

(52) U.S. Cl. CPC G06T 7/0008; B08B 3/04; B08B 13/00; G06T 2207/30148

(57) ABSTRACT

A substrate processing system includes: a batch processor configured to collectively process substrates; a single-wafer processor configured to process the substrates one by one; an interface configured to deliver the substrates from the batch processor to the single-wafer processor; and a control circuit, wherein the interface includes: a substrate holder configured to hold a substrate among the substrates; a processing liquid supply configured to supply a processing liquid, which suppresses drying of an upper surface of the substrate held by the substrate holder, to the upper surface of the substrate; and an image capturer configured to capture the upper surface of the substrate, and wherein the control circuit performs control for determining whether the processing liquid supply supplies the processing liquid to the upper surface of the substrate based on an image of the upper surface of the substrate captured by the image capturer.

### CROSS-REFERENCE TO RELATED APPLICATION

This application is based upon and claims the benefit of priority from Japanese Patent Application No. 2024-109799, filed on Jul. 8, 2024, the entire contents of which are incorporated herein by reference.

### TECHNICAL FIELD

The present disclosure relates to a substrate processing system.

### BACKGROUND

A substrate processing system including a batch processor, a single-wafer processor, and an interface is known. The batch processor collectively processes a lot including substrates. The single-wafer processor processes the substrates of the lot one by one. The interface delivers the substrates from the batch processor to the single-wafer processor.

### PRIOR ART DOCUMENTS

### Patent Documents

Patent Document 1: Japanese Patent Laid-Open Publication No. 2023-129235

Patent Document 2: Japanese Patent Laid-Open Publication No. 2023-121707

Patent Document 3: Japanese Patent Laid-Open Publication No. 2023-121571

### SUMMARY

According to one embodiment of the present disclosure, there is provided a substrate processing system including: a batch processor configured to collectively process substrates; a single-wafer processor configured to process the substrates one by one; an interface configured to deliver the substrates from the batch processor to the single-wafer processor; and a control circuit, wherein the interface includes: a substrate holder configured to hold a substrate among the substrates; a processing liquid supply configured to supply a processing liquid, which suppresses drying of an upper surface of the substrate held by the substrate holder, to the upper surface of the substrate; and an image capturer configured to capture the upper surface of the substrate, and wherein the control circuit performs control for determining whether the processing liquid supply supplies the processing liquid to the upper surface of the substrate based on an image of the upper surface of the substrate captured by the image capturer.

### BRIEF DESCRIPTION OF DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a schematic plane view illustrating a substrate processing system according to an embodiment.

FIGS. 2A and 2B are diagrams illustrating a second delivery stage according to a first example of an embodiment.

FIG. 3 is a flowchart illustrating a substrate processing method according to an embodiment.

FIG. 4 is a flowchart illustrating an example of surface determination control.

FIG. 5 is a cross-sectional view (1) illustrating an example of the surface determination control.

FIG. 6 is a cross-sectional view (2) illustrating an example of the surface determination control.

FIG. 7 is a cross-sectional view (3) illustrating an example of the surface determination control.

FIG. 8 is a diagram illustrating an example of an upper surface image of a substrate having a lyophilic upper surface.

FIG. 9 is a diagram illustrating an example of an upper surface image of a substrate having a lyophobic upper surface.

FIGS. 10A and 10B are diagrams illustrating a second delivery stage according to a second example of an embodiment.

FIGS. 11A and 11B are diagrams illustrating a second delivery stage according to a third example of an embodiment.

FIG. 12 is a flowchart illustrating an example of slope determination control.

FIG. 13 is a cross-sectional view (1) illustrating an example of the slope determination control.

FIG. 14 is a cross-sectional view (2) illustrating an example of the slope determination control.

FIG. 15 is a cross-sectional view (3) illustrating an example of the slope determination control.

FIG. 16 is a cross-sectional view (4) illustrating an example of the slope determination control.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

Hereinafter, non-limitative exemplary embodiments of the present disclosure are described with reference to the accompanying drawings. In all the attached drawings, the same or corresponding members or components are denoted by the same or corresponding reference numerals, and a repeated description thereof is omitted.

In the following description, while the XYZ rectangular coordinate system is used, the coordinate system is determined for the purpose of explanation and does not limit the orientation of a substrate processing system 1. When viewed from the XY plane, this may be called a plane view, and when viewed from any point, a positive side of the Z-axis may be called an upward direction, and a negative side of the Z-axis may be called a downward direction.

### Substrate Processing System

The substrate processing system 1 according to an embodiment is described with

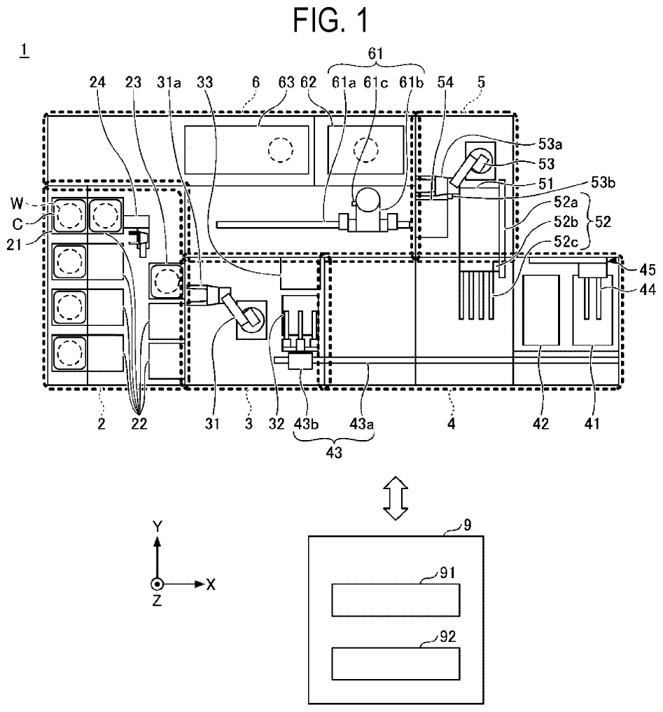

reference to FIG. 1. FIG. 1 is a schematic plane view illustrating the substrate processing system 1 according to an embodiment.

As illustrated in FIG. 1, the substrate processing system 1 includes a loading/unloading part 2, a first interface 3, a batch processor 4, a second interface 5, a single-wafer processor 6, and a control circuit 9.

The loading/unloading part 2 serves as both a loading part and an unloading part. It is therefore possible to reduce a size of the substrate processing system 1. The loading/unloading part 2 includes a load port 21, stockers 22, a loader 23, and a cassette transferrer 24.

The load port 21 is disposed on a negative side of the X-axis of the loading/unloading part 2. A plurality (e.g., four) of load ports 21 are disposed along the Y-axis. The number of the load ports 21 is not particularly limited. Cassettes C are placed on the load ports 21. Each cassette C accommodates multiple sheets (e.g., 25 sheets) of substrates W and is loaded and unloaded via the load port 21. The substrates W are held horizontally inside the cassette C and held at a second pitch P2, which is N times a first pitch P1 (P2=N×P1), along the Z-axis. Nis a natural number equal to or greater than 2. N is 2 in the present embodiment but may be 3 or greater.

The stockers 22 are disposed in multiples (e.g. four) along the Y-axis at a center of the X-axis of the loading/unloading part 2. The stockers 22 are disposed in multiples (e.g. two) adjacent to the first interface 3 along the Y-axis on a positive side of the X-axis of the loading/unloading part 2. The stockers 22 may be disposed in multiple stages along the Z-axis. The stockers 22 temporarily store the cassette C accommodating the substrates W before cleaning processing, the cassette C whose is empty after the substrates W are retrieved, and the like. The number of the stockers 22 is not particularly limited.

The loader 23 is adjacent to the first interface 3. The loader 23 is disposed on the positive side of the X-axis of the loading/unloading part 2. The cassettes C are placed on the loader 23. The loader 23 is provided with a lid opening/closing mechanism (not illustrated) for opening and closing a lid of the cassette C. A plurality of loaders 23 may be provided. The loaders 23 may be disposed in multiple stages along the Z-axis.

The cassette transferrer 24 transfers the cassettes C among the load port 21, the stockers 22, and the loader 23. The cassette transferrer 24 is, for example, an articulated transfer robot.

The first interface 3 is disposed on the positive side of the X-axis of the loading/unloading part 2. The first interface 3 transfers the substrates W among the loading/unloading part 2, the batch processor 4, and the single-wafer processor 6. The first interface 3 includes a substrate transfer device 31, a lot former 32, and a first delivery stage 33.

The substrate transfer device 31 transfers the substrates W among the cassette C placed on the loader 23, the lot former 32, and the first delivery stage 33. The substrate transfer device 31 is composed of a multi-axis (e.g., six-axis) arm robot and includes a substrate holding arm 31a at a tip end thereof. The substrate holding arm 31a includes a plurality of holding hooks (not illustrated) that are capable of holding the multiple sheets (e.g., 25 sheets) of substrates W. The substrate holding arm 31a may take any position and orientation in a three-dimensional space while holding the substrates W with the holding hooks.

The lot former 32 is disposed on the positive side of the X-axis of the first interface 3. The lot former 32 holds the substrates W at the first pitch P1 and forms a lot L.

The first delivery stage 33 is adjacent to the single-wafer processor 6. The first delivery stage 33 is disposed on a positive side of the Y-axis of the first interface 3. The first delivery stage 33 receives the substrates W from a fourth transferrer 61 and temporarily stores the substrates W until the substrates W are delivered to the loading/unloading part 2.

The batch processor 4 is disposed on the positive side of the X-axis of the first interface 3. The loading/unloading part 2, the first interface 3, and the batch processor 4 are disposed in this order from the negative side of the X-axis toward the positive side of the X-axis. The batch processor 4 collectively processes the lot L including the multiple sheets (e.g., 50 or 100 sheets) of substrates W at the first pitch P1. One lot L is composed of the substrates W of, for example, M cassettes C. M is a natural number equal to or greater than 2. M may be the same natural number as N or may be a natural number different from N. The batch processor 4 includes a chemical liquid bath 41, a rinse liquid bath 42, a first transferrer 43, a processing tool 44, and a driver 45.

The chemical liquid bath 41 and the rinse liquid bath 42 are disposed along the X-axis. For example, the chemical liquid bath 41 and the rinse liquid bath 42 are disposed in this order from the positive side of the X-axis toward the negative side of the X-axis. The chemical liquid bath 41 and the rinse liquid bath 42 are collectively referred to as a processing bath. The number of chemical liquid baths 41 and rinse liquid baths 42 is not limited to that illustrated in FIG. 1. For example, the chemical liquid bath 41 and the rinse liquid bath 42 are one set in FIG. 1 but may be a plurality of sets.

The chemical liquid bath 41 stores a chemical liquid in which the lot L is immersed. The chemical liquid is, for example, an aqueous phosphoric acid solution (H₃PO₄). The aqueous phosphoric acid solution selectively etches and removes a silicon nitride film from among a silicon oxide film and the silicon nitride film. The chemical liquid is not limited to the aqueous phosphoric acid solution. The chemical liquid may be dilute hydrofluoric acid (DHF), a mixture of hydrofluoric acid and ammonium fluoride (BHF), dilute sulfuric acid, a mixture of sulfuric acid, hydrogen peroxide, and water (SPM), a mixture of ammonia, hydrogen peroxide, and water (SC1), a mixture of hydrochloric acid, hydrogen peroxide, and water (SC2), a mixture of tetramethylammonium hydroxide and water (TMAH), a plating liquid, etc. The chemical liquid may be used for stripping processing or plating processing. The number of chemical liquids is not particularly limited and may be multiple.

The rinse liquid bath 42 stores a first rinse liquid in which the lot L is immersed. The first rinse liquid is pure water that removes the chemical liquid from the substrate W and is, for example, deionized water (DIW).

The first transferrer 43 includes a guide rail 43a and a first transfer arm 43b. The guide rail 43a is disposed on a negative side of the Y-axis compared to the processing bath. The guide rail 43a extends along the X-axis from the first interface 3 to the batch processor 4. The first transfer arm 43b moves along the guide rail 43a. The first transfer arm 43b may move along the Z-axis or rotate around the Z-axis. The first transfer arm 43b collectively transfers the lot L between the first interface 3 and the batch processor 4.

The processing tool 44 receives the lot L from the first transfer arm 43b and holds the lot L. The processing tool 44 holds the substrates W at the first pitch Pl along the Y-axis and holds each of the substrates W vertically.

The driver 45 moves the processing tool 44 along X-axis and the Z-axis. The processing tool 44 immerses the lot L in the chemical liquid stored in the chemical liquid bath 41, immerses the lot L in the first rinse liquid stored in the rinse liquid bath 42, and then delivers the lot L to the first transferrer 43.

The number of units of the processing tool 44 and the driver 45 is one in the present embodiment but may be multiple. In the latter case, one unit immerses the lot L in the chemical liquid stored in the chemical liquid bath 41, and another unit immerses the lot L in the first rinse liquid stored in the rinse liquid bath 42. In this case, the driver 45 only needs to move the processing tool 44 along the Z-axis and does not need to move the processing tool 44 along the X-axis.

The second interface 5 is disposed on the positive side of the Y-axis of the batch processor 4. The second interface 5 transfers the substrates W between the batch processor 4 and the single-wafer processor 6. The second interface 5 includes an immersion bath 51, a second transferrer 52, a third transferrer 53, and a second delivery stage 54.

The immersion bath 51 is disposed outside a movement range of the first transfer arm 43b. For example, the immersion bath 51 is disposed at a position shifted toward the positive side of the Y-axis with respect to the processing bath. The immersion bath 51 stores a second rinse liquid in which the lot L is immersed. The second rinse liquid is, for example, DIW. The substrates W are held in the second rinse liquid until the substrates W are lifted from the second rinse liquid by the third transferrer 53. Since the substrates W are present below a liquid level of the second rinse liquid, surface tension of the second rinse liquid does not act on the substrates W, making it possible to prevent concavo-convex patterns of the substrates W from collapsing.

The second transferrer 52 includes a Y-axis driver 52a, a Z-axis driver 52b, and a second transfer arm 52c.

The Y-axis driver 52a is disposed on the positive side of the X-axis of the second interface 5. The Y-axis driver 52a extends along the Y-axis from the second interface 5 to the batch processor 4. The Y-axis driver 52a moves the Z-axis driver 52b and the second transfer arm 52c along the Y-axis. The Y-axis driver 52a may include a ball screw.

The Z-axis driver 52b is movably attached to the Y-axis driver 52a. The Z-axis driver 52b moves the second transfer arm 52c along the Z-axis. The Z-axis driver 52b may include a ball screw.

The second transfer arm 52c is movably attached to the Z-axis driver 52b. The second transfer arm 52c receives the lot L from the first transfer arm 43b and holds the lot L. The second transfer arm 52c holds the substrates W at the first pitch P1 along the Y-axis and holds each of the substrates W vertically. The second transfer arm 52c moves along the Y-axis and the Z-axis by the Y-axis driver 52a and the Z-axis driver 52b. The second transfer arm 52c is configured to be movable among multiple positions including a delivery position, an immersion position, and a standby position.

The delivery position is a position at which the lot L is delivered between the first transfer arm 43b and the second transfer arm 52c. The delivery position is a position on the negative side of the Y-axis and the positive side of the Z-axis.

The immersion position is a position at which the lot L is immersed in the immersion bath 51. The immersion position is a position on the positive side of the Y-axis and the negative side of the Z-axis compared to the delivery position.

The standby position is a position at which the second transfer arm 52c waits when the lot L is not being delivered or is not being immersed in the immersion bath 51. The standby position is directly below the delivery position (negative side of the Z-axis) and is a position that does not interfere with movement of the first transfer arm 43b. In this case, since it is possible for the second transfer arm 52c to move to the delivery position only by moving upward (positive side of the Z-axis), throughput is improved. The standby position may be the same position as the immersion position. In this case, it is possible to prevent particles, which may be generated by the operation of the first transferrer 43, from being attached to the second transfer arm 52c. The standby position may be a position directly above the immersion position (positive side of the Z-axis). In this way, by setting the standby position to a position different from the delivery position, it is possible to prevent contact between the first transfer arm 43b and the second transfer arm 52c.

The second transferrer 52 moves the second transfer arm 52c to the immersion position or the standby position while the first transferrer 43 is operating. This makes it possible to prevent contact between the first transfer arm 43b and the second transfer arm 52c.

The third transferrer 53 is composed of a multi-axis (e.g., six-axis) arm robot and includes a third transfer arm 53a at a tip end thereof. The third transfer arm 53a includes a holding hook (not illustrated) capable of holding one sheet of substrate W. The third transfer arm 53a may take any position and orientation in three-dimensional space while holding the substrate W with the holding hook. The third transferrer 53 transfers the substrate W between the second transfer arm 52c located at the immersion position and the second delivery stage 54. In this case, since the immersion bath 51 is disposed outside a movement range of the first transfer arm 43b, the first transfer arm 43b and the third transfer arm 53a do not interfere with each other. This allows one of the first transferrer 43 and the third transferrer 53 to operate independently, regardless of an operating state of the other. Therefore, since it is possible to operate the first transferrer 43 and the third transferrer 53 at any timing, it is possible to shorten a time required to transfer the substrate W. As a result, productivity of the substrate processing system 1 is improved.

The third transferrer 53 includes an image capturer 53b. The image capturer 53b is attached to, for example, the third transfer arm 53a. The image capturer 53b captures an upper surface of the substrate W being transferred by the third transfer arm 53a to acquire a first upper surface image, which is an image of the upper surface of the substrate W. The image capturer 53b transmits the acquired first upper surface image to the control circuit 9. The image capturer 53b may include a camera and generate the image by using the camera. The image capturer 53b may include a laser light source and the camera and generate the image by using an optical cutting method. The image capturer 53b only needs to be capable of capturing the upper surface of the substrate W being transferred by the third transfer arm 53a and may be attached to a side wall or ceiling of the second interface 5. In the example of FIG. 1, one image capturer 53b is provided, but two or more image capturers 53b may also be used. The image capturer 53b is an example of a first image capturer.

The second delivery stage 54 is adjacent to the single-wafer processor 6. The second delivery stage 54 is disposed on the negative side of the X-axis of the second interface 5. The second delivery stage 54 receives the substrates W from the third transferrer 53 and temporarily stores the substrates W until the substrates W are delivered to the single-wafer processor 6. The substrates W retrieved from the immersion bath 51 are placed on the second delivery stage 54. The substrates W placed on the second delivery stage 54 are preferably in a state in which, for example, surfaces of the substrates W are wet with the second rinse liquid. In this case, the surface tension of the second rinse liquid does not act on the substrates W, making it possible to suppress the collapse of the concavo-convex patterns of the substrates W. The number of second delivery stages 54 may be one or plural. Details of the second delivery stage 54 are described later.

The single-wafer processor 6 is disposed on the negative side of the X-axis of the second interface 5. The single-wafer processor 6 is disposed on the positive side of the Y-axis of the loading/unloading part 2, the first interface 3, and the batch processor 4. The single-wafer processor 6 processes the substrates W one by one. The single-wafer processor 6 includes the fourth transferrer 61, a liquid processor 62, and a dryer 63.

The fourth transferrer 61 includes a guide rail 61a, a fourth transfer arm 61b, and an image capturer 61c.

The guide rail 61a is disposed on the negative side of the Y-axis of the single-wafer processor 6. The guide rail 61a extends along the X-axis in the single-wafer processor 6.

The fourth transfer arm 61b moves along the guide rail 61a. The fourth transfer arm 61b rotates around the Z-axis. The fourth transfer arm 61b transfers the substrates W among the second delivery stage 54, the liquid processor 62, the dryer 63, and the first delivery stage 33. The number of fourth transfer arms 61b may be one or plural. In the latter case, the fourth transferrer 61 collectively transfers the multiple sheets (e.g., five sheets) of substrates W.

The image capturer 61c is attached to the fourth transfer arm 61b. The image capturer 61c captures the upper surface of the substrate W being transferred by the fourth transfer arm 61b to acquire a second upper surface image, which is an image of the upper surface of the substrate W. The image capturer 61c transmits the acquired second upper surface image to the control circuit 9. The image capturer 61c may include a camera and generate the image by using the camera. The image capturer 61c may include a laser light source and the camera and generate the image by using the optical cutting method. The image capturer 61c only needs to be capable of capturing the upper surface of the substrate W being transferred by the fourth transfer arm 61b and may be attached to a side wall or ceiling of the single-wafer processor 6. In the example of FIG. 1, one image capturer 61c is provided, but two or more image capturers 61c may also be used.

The liquid processor 62 is disposed on the positive side of the X-axis and the positive side of the Y-axis of the single-wafer processor 6. The liquid processor 62 is a single-wafer type and processes the substrates W one by one with a processing liquid. The liquid processor 62 is disposed in multiple stages (e.g., three stages) along the Z-axis. This allows the substrates W to be processed simultaneously with the processing liquid. The processing liquid may include a plurality of liquids, for example, pure water, such as DIW, and a drying liquid having a lower surface tension than pure water. The drying liquid may be an alcohol such as isopropyl alcohol (IPA).

The dryer 63 is disposed adjacent to the liquid processor 62 on the negative side of the X-axis. In this case, an end surface of the single-wafer processor 6 on the positive side of the Y-axis may be disposed so as to be flush or substantially flush with an end surface of the second interface 5 on the positive side of the Y-axis. This results in almost no dead space, making it possible to reduce footprint of the substrate processing system 1. In contrast, if the dryer 63 is disposed toward the positive side of the Y-axis with respect to the liquid processor 62, the end surface of the single-wafer processor 6 on the positive side of the Y-axis may protrude farther than the end surface of the second interface 5 on the positive side of the Y-axis, resulting in a dead space. The dryer 63 is a single-wafer type and dries the substrates W one by one with a supercritical fluid. The dryer 63 is disposed in multiple stages (e.g., three stages) along the Z-axis. This allows the substrates W to be dried simultaneously.

Both the liquid processor 62 and the dryer 63 may not be a single-wafer type, or the liquid processor 62 may be a single-wafer type and the dryer 63 may be a batch type. The dryer 63 may collectively dry the substrates W with the supercritical fluid. The number of the substrates W collectively processed in the dryer 63 may be equal to or greater than the number of the substrates W collectively processed in the liquid processor 62 but may be less. Devices other than the liquid processor 62 and the dryer 63 may be disposed in the single-wafer processor 6.

The control circuit 9 is, for example, a computer, and includes a calculator 91 such as a central processing unit (CPU) and a storage 92 such as a memory. The storage 92 is a computer readable storage medium that stores programs that control various processes executed in the substrate processing system 1. The control circuit 9 controls the operation of the substrate processing system 1 by executing the programs, stored in the storage 92, in the calculator 91.

The control circuit 9 includes electronic circuits such as the CPU, a field programmable gate array (FPGA), and an application specific integrated circuit (ASIC). The control circuit 9 executes various control operations described in the present disclosure by executing instruction codes stored in the memory or by being circuit-designed for a specific purpose.

In the substrate processing system 1, the substrates W are transferred in the order from the loading/unloading part 2 to the first interface 3, the batch processor 4, the second interface 5, and the single-wafer processor 6 and then return to the loading/unloading part 2.

### Second Delivery Stage of First Example

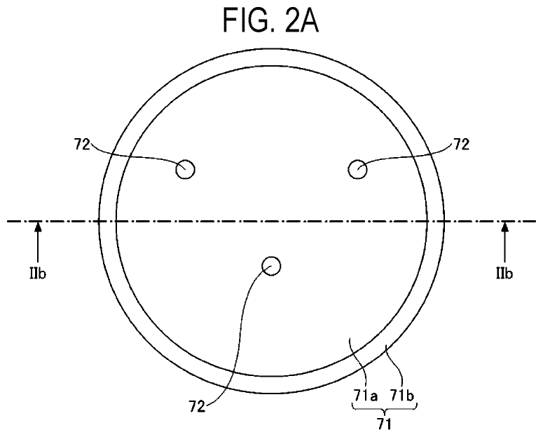

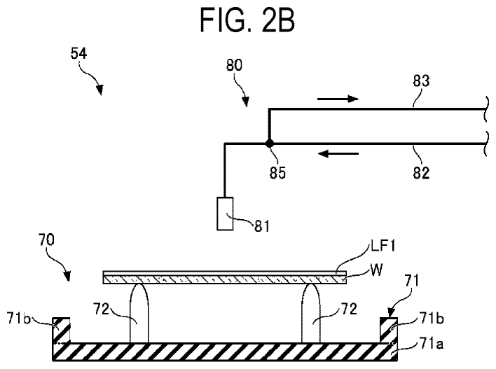

The second delivery stage 54 according to a first example is described with reference to FIGS. 2A and 2B. FIGS. 2A and 2B illustrate the second delivery stage 54 according to the first example of an embodiment. FIG. 2A is a plane view, and FIG. 2B is a cross-sectional view. FIG. 2B is a cross-sectional view taken along line IIb-IIb in FIG. 2A.

As illustrated in FIGS. 2A and 2B, the second delivery stage 54 according to the first example includes a substrate holder 70 and a pure water supply 80. In FIG. 2A, the pure water supply 80 is omitted.

The substrate holder 70 includes a liquid receiver 71 and a plurality of pins 72. The liquid receiver 71 includes a bottom plate 71a and a wall 71b. The bottom plate 71a has a disc shape. The wall 71b is annularly provided on the bottom plate 71a. The plurality of pins 72 are provided on the bottom plate 71a. In the example illustrated in FIG. 2A, the number of pins 72 is three but may be four or more. A surface including an upper end of each pin 72 is horizontal. The upper end of each pin 72 is positioned above an upper end of the wall 71b. The plurality of pins 72 supports the substrate W from below at an upper side of the bottom plate 71a. A first liquid film LF1, which is a liquid film of the second rinse liquid, may be formed on the upper surface of the substrate W.

The pure water supply 80 includes a nozzle 81, a pure water supply line 82, and a return line 83. The pure water supply line 82 is connected to the nozzle 81. The nozzle 81 discharges pure water supplied through the pure water supply line 82. A branch point 85 is provided at the pure water supply line 82, and the return line 83 is connected to the branch point 85. Even during a period when pure water is not being discharged from the nozzle 81, pure water flows through a portion upstream of the branch point 85 of the pure water supply line 82 and through the return line 83. The pure water supply 80 configured in this way supplies pure water to the upper surface of the substrate W. The pure water supply 80 is an example of a processing liquid supply.

### Operation of Substrate Processing System

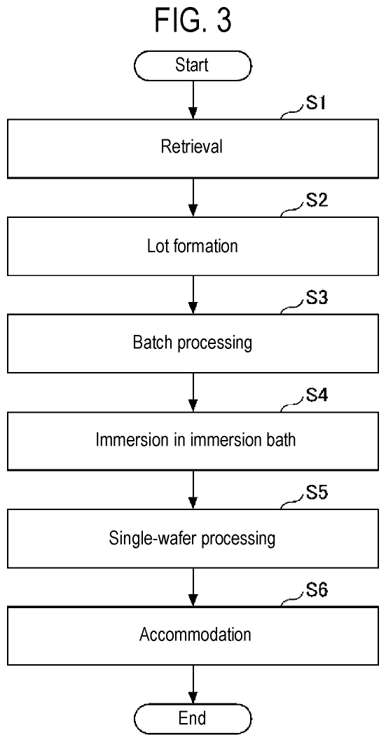

The operation of the substrate processing system 1 according to an embodiment, i.e., a substrate processing method, is described with reference to FIGS. 1 and 3. FIG. 3 is a flowchart illustrating a substrate processing method according to an embodiment. A process illustrated in FIG. 3 is performed under control of the control circuit 9.

First, the cassette C is loaded into the loading/unloading part 2 while accommodating the substrates W and is placed on the load port 21. Inside the cassette C, the substrates W are held horizontally along the Z-axis at the second pitch P2 (P2=N×P1). N is a natural number of 2 or more, which is 2 in the present embodiment but may be 3 or more.

Next, the cassette transferrer 24 transfers the cassette C from the load port 21 to the loader 23. When the cassette C is transferred to the loader 23, the lid of the cassette C is opened by the lid opening/closing mechanism.

Next, the substrate transfer device 31 receives the substrates W accommodated in the cassette C (S1 in FIG. 3) and transfers the substrates W to the lot former 32.

Next, the lot former 32 holds the substrates W at the first pitch P1 (P1=P2/N) to form the lot L (S2 in FIG. 3). One lot L is composed of, for example, the substrates W of M cassettes C. Since the pitch of the substrates W narrows from the second pitch P2 to the first pitch P1, it is possible to increase the number of the substrates W to be collectively processed.

Next, the first transferrer 43 receives the lot L from the lot former 32 and transfers the lot L to the processing tool 44.

Next, the processing tool 44 descends from above the chemical liquid bath 41, immerses the lot L in the chemical liquid, and performs chemical processing (S3 in FIG. 3). Thereafter, the processing tool 44 rises to lift the lot L from the chemical liquid and then moves to the negative side of the X-axis toward above the rinse liquid bath 42.

Next, the processing tool 44 descends from above the rinse liquid bath 42, immerses the lot L in the first rinse liquid, and performs rinse liquid processing (S3 in FIG. 3). Thereafter, the processing tool 44 rises to lift the lot L from the first rinse liquid. Next, the first transferrer 43 receives the lot L from the processing tool 44 and transfers the lot L to the second transferrer 52.

Next, the second transfer arm 52c of the second transferrer 52 moves to the positive side of the Y-axis and descends from above the immersion bath 51 to immerse the lot L in the second rinse liquid (S4 in FIG. 3). The substrates W of the lot L are held in the second rinse liquid until the substrates W are lifted from the second rinse liquid by the third transferrer 53. Since the substrates W are present below the liquid level of the second rinse liquid, the surface tension of the second rinse liquid does not act on the substrates W, thereby preventing the concavo-convex patterns of the substrates W from collapsing.

Next, the third transferrer 53 transfers the substrates W of the lot L held by the second transfer arm 52c in the second rinse liquid to the second delivery stage 54. The third transferrer 53, for example, transfers the substrates W one by one to the second delivery stage 54. In order to prevent the concavo-convex patterns from collapsing due to drying of the upper surfaces of the substrates W, the second delivery stage 54 discharges pure water onto the upper surface of the substrate W to form a second liquid film LF2, which is a liquid film of pure water.

Next, the fourth transferrer 61 receives the substrates W from the second delivery stage 54 and transfers the substrates W to the liquid processor 62.

Next, the liquid processor 62 processes the substrates W one by one with a liquid (step S5 in FIG. 3). The number of liquids may be multiple and the liquids may be, for example, pure water such as DIW and a drying liquid having a lower surface tension than pure water. The drying liquid may be an alcohol such as IPA. The liquid processor 62 supplies pure water and the drying liquid in this order to the upper surfaces of the substrates W to form liquid films of the drying liquid.

Next, the fourth transferrer 61 receives the substrates W from the liquid processor 62 and holds the substrates W horizontally with the liquid films of the drying liquid facing upward. The fourth transferrer 61 transfers the substrates W from the liquid processor 62 to the dryer 63.

Next, the dryer 63 dries the substrates W one by one with a supercritical fluid (S5 in FIG. 3). Since it is possible to replace the drying liquid with the supercritical fluid, it is possible to suppress the collapse of the concavo-convex patterns of the substrates W caused by the surface tension of the drying liquid. Since the supercritical fluid requires a pressure-resistant container, the substrates W are processed by single-wafer processing rather than batch processing in order to reduce the size of the pressure-resistant container.

Further, in the present embodiment, the dryer 63 is a single-wafer type but, as described above, may be a batch type. The batch-type dryer 63 collectively dries, with the supercritical fluid, the substrates W on which the liquid films have been formed. The single-wafer-type dryer 63 has one transfer arm for holding the substrates W, whereas the batch-type dryer 63 has a plurality of transfer arms.

In the present embodiment, while the dryer 63 dries the substrates W with the supercritical fluid, the drying method is not particularly limited. The drying method may be any method that is capable of suppressing the collapse of the concavo-convex patterns of the substrates W and may be, for example, spin drying, scan drying, water-repellent drying, or the like. The spin drying is a method in which the liquid processor 62 rotates the substrate W to remove the drying liquid from the upper surface of the substrate W by shaking the drying liquid off the substrate W using centrifugal force. The scan drying includes shaking the liquid film off the substrate W using centrifugal force by rotating the substrate W while a supply position of the drying liquid is moved from a center of the substrate W to an outer periphery of the substrate W. The scan drying may include moving a supply position of a drying gas, such as nitrogen gas, from the center of the substrate W toward the outer periphery of the substrate W so as to follow the supply position of the drying liquid.

Next, the fourth transferrer 61 receives the substrates W from the dryer 63 and transfers the substrates W to the first delivery stage 33.

Next, the substrate transfer device 31 receives the substrates W from the first delivery stage 33 and accommodates the substrates W in the cassette C (S6 in FIG. 3). The cassette C is unloaded from the loading/unloading part 2 in a state in which the substrates W are accommodated therein.

However, in the substrate processing system 1, when the substrate W is transferred from the batch processor 4 to the single-wafer processor 6, pure water is discharged onto the upper surface of the substrate W in the second delivery stage 54 to form the second liquid film LF2. In this case, if the upper surface of the substrate W loaded into the second delivery stage 54 is lyophobic (hydrophobic), when pure water is discharged onto the upper surface of the substrate W, pure water may splash out on the upper surface of the substrate W and fall from the substrate W during transfer. In such a case, maintenance of the substrate processing system 1 is carried out, resulting in a decrease in an operation rate of the substrate processing system 1.

For example, when evaluating etching characteristics of a silicon nitride film by etching a monitor substrate, having the silicon nitride film formed on its surface, with a phosphoric acid aqueous solution, there are cases in which a bare silicon substrate is included as a dummy substrate in a portion of the lot L. In this case, the upper surfaces of some substrates in the lot L may become lyophobic. This is because upper surfaces of the monitor substrates etched with the phosphoric acid aqueous solution become lyophilic (hydrophilic), whereas upper surfaces of the bare silicon substrates etched with the phosphoric acid aqueous solution becomes lyophobic. For example, if a dummy substrate used in another process is used, the surfaces of some substrates in the lot L may become lyophobic. For example, if an irregular event occurs during processing of a product substrate, the upper surface of that substrate may become lyophobic.

Hereinbelow, a technique is described that is capable of suppressing a decrease in the operation rate of the substrate processing system 1 by suppressing drop of pure water from the substrate W when the substrate W, the upper surface of which is lyophobic, is transferred from the batch processor 4 to the single-wafer processor 6.

### Surface Determination Control

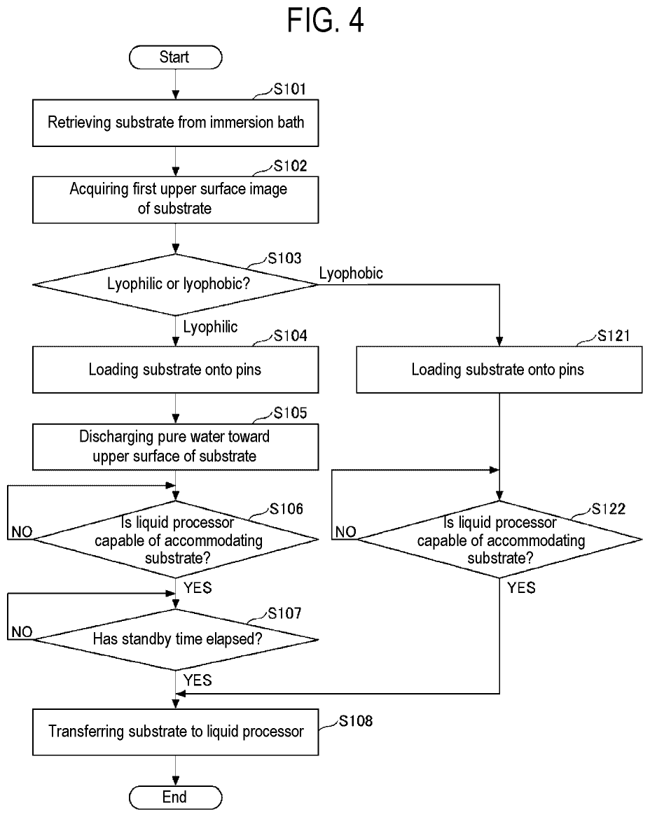

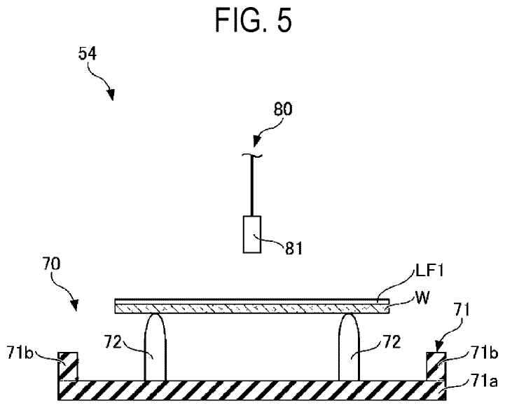

An example of control for determining whether the pure water supply 80 supplies pure water to the upper surface of the substrate W based on the first upper surface image (hereinafter referred to as “surface determination control”) is described with reference to FIGS. 4 to 9. The surface determination control is performed when transferring the substrate W immersed in the immersion bath 51 of the second interface 5 to the single-wafer processor 6. FIG. 4 is a flowchart illustrating an example of the surface determination control. FIGS. 5 to 7 are cross-sectional views illustrating an example of the surface determination control. A process illustrated in FIG. 4 is performed under control of the control circuit 9.

In step S101, the third transferrer 53 retrieves the substrate W of the lot L held by the second transfer arm 52c from the second rinse liquid in the immersion bath 51.

In step S102, the third transferrer 53 transfers the substrate W held in a horizontal orientation by the third transfer arm 53a to the second delivery stage 54. Herein, the first liquid film LF1, which is the liquid film of the second rinse liquid, is formed on the upper surface of the substrate W. When the third transferrer 53 transfers the substrate W, the image capturer 53b captures the upper surface of the substrate W being transferred by the third transfer arm 53a to acquire the first upper surface image, which is the image of the upper surface of the substrate W. The image capturer 53b transmits the acquired first upper surface image to the control circuit 9. In this way, in step S102, the image capturer 53b captures the upper surface of the substrate W before the substrate W is transferred to the second delivery stage 54.

In step S103, the control circuit 9 determines whether the upper surface of the substrate W is lyophilic or lyophobic based on the first upper surface image. For example, the control circuit 9 calculates a ratio of an area covered by the first liquid film LF1 to an entire area of the upper surface of the substrate W in the first upper surface image (hereinafter referred to as “first area ratio”) and determines whether the upper surface of the substrate W is lyophilic or lyophobic based on whether the calculated first area ratio is equal to or greater than a threshold. If the first area ratio is equal to or greater than the threshold, the control circuit 9 determines that the upper surface of the substrate W is lyophilic. If the first area ratio is less than the threshold, the control circuit 9 determines that the upper surface of the substrate W is lyophobic. The threshold is, for example, 100%. The threshold may be a value less than 100% and may be, for example, 90%. The control circuit 9 may store the first area ratio in association with information identifying the substrate W (e.g., substrate ID). In this case, when a product defect occurs, it becomes easy to identify the cause.

In the present embodiment, first, the control circuit 9 performs a binarization process on the first upper surface image to calculate a ratio of the number of black pixels to the total number of pixels including black and white (hereinafter referred to as “black ratio”) and determines whether the upper surface of the substrate W is lyophilic or lyophobic based on whether the calculated black ratio is equal to or greater than a threshold. If the black ratio is equal to or greater than the threshold, the control circuit 9 determines that the upper surface of the substrate W is lyophilic. If the black ratio is less than the threshold, the control circuit 9 determines that the upper surface of the substrate W is lyophobic. The threshold is, for example, 100%. The threshold may be a value less than 100% or may be, for example, 90%. The control circuit 9 may store the black ratio in association with information identifying the substrate W (e.g., substrate ID). In this case, when a product defect occurs, it becomes easy to identify the cause.

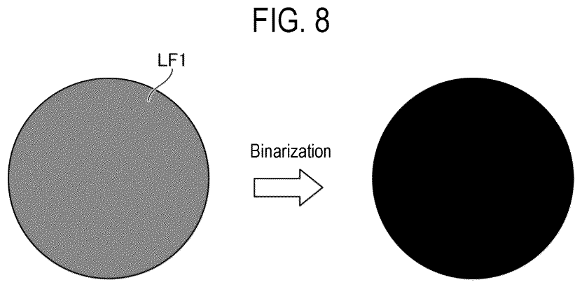

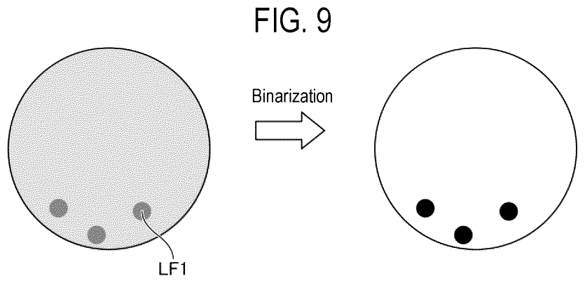

FIG. 8 is a diagram illustrating an example of an upper surface image of the substrate W having a lyophilic upper surface. FIG. 9 is a diagram illustrating an example of an upper surface image of the substrate W having a lyophobic upper surface. In each of FIGS. 8 and 9, the left drawing shows the first upper surface image before binarization, and the right drawing shows the first upper surface image after binarization. In the example of FIG. 8, the first liquid film LF1 is formed over the entire upper surface of the substrate W, and the black ratio of the first upper surface image after binarization is 100%. In this case, the control circuit 9 determines that the upper surface of the substrate W is lyophilic. In the example of FIG. 9, the first liquid film LF1 is formed over a portion of the upper surface of the substrate W, and the black ratio of the first upper surface image after binarization is 1%. In this case, the control circuit 9 determines that the upper surface of the substrate W is lyophobic.

If the upper surface of the substrate W is determined to be lyophilic in step S103, the control circuit 9 proceeds to step S104. If the upper surface of the substrate W is determined to be lyophobic in step S103, the control circuit 9 proceeds to step S121. That is, if it is determined that the upper surface of the substrate W is lyophobic, the second liquid film LF2 is not formed on the upper surface of the substrate W. In this case, when the fourth transferrer 61 transfers the substrate W from the substrate holder 70 to the liquid processor 62, it is possible to suppress droplets from falling from the upper surface of the substrate W, thereby reducing maintenance frequency. Therefore, it is possible to suppress a decrease in the operation rate of the substrate processing system 1.

In step S104, the third transferrer 53 transfers the substrate W held by the third transfer arm 53a to the second delivery stage 54, and, as illustrated in FIG. 5, the substrate W is loaded onto the three pins 72.

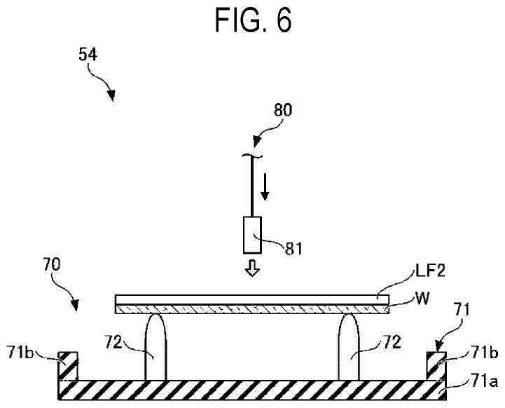

In step S105, as illustrated in FIG. 6, the nozzle 81 discharges pure water toward the upper surface of the substrate W. As a result, the second liquid film LF2, which is a pure water film, is formed on the upper surface of the substrate W. After the second liquid film LF2 is formed on the upper surface of the substrate W, the nozzle 81 stops discharging pure water to the substrate W.

In step S106, the control circuit 9 determines whether the liquid processor 62 is capable of accommodating the substrate W. For example, when the substrate W is not present in the liquid processor 62, the control circuit 9 determines that the liquid processor 62 is capable of accommodating the substrate W. For example, when the substrate W is present in the liquid processor 62, the control circuit 9 determines that the liquid processor 62 is incapable of accommodating the substrate W.

If it is determined in step S106 that the liquid processor 62 is capable of accommodating the substrate W (“Yes” in step S106), the control circuit 9 proceeds to step S107. If it is determined in step S106 that the liquid processor 62 is incapable of accommodating the substrate W (“No” in step S106), the control circuit 9 causes the substrate W to wait on the second delivery stage 54 until the liquid processor 62 becomes capable of accommodating the substrate W.

In step S107, the control circuit 9 determines whether a predetermined standby time has elapsed from the time when the substrate W is transferred to the second delivery stage 54. The predetermined standby time is set in advance by, for example, a processing recipe. The predetermined standby time may be 0 seconds. In other words, step S107 may be omitted.

In step S107, if it is determined that the predetermined standby time has elapsed (“Yes” in step S107), the control circuit 9 proceeds to step S108. If it is determined that the predetermined standby time has not elapsed (“No” in step S107), the control circuit 9 causes the substrate W to wait on the second delivery stage 54 until the predetermined standby time has elapsed.

In step S121, the third transferrer 53 transfers the substrate W held by the third transfer arm 53a to the second delivery stage 54 and loads the substrate W onto the three pins 72 as illustrated in FIG. 5.

In step S122, the control circuit 9 determines whether the liquid processor 62 is capable of accommodating the substrate W. For example, if the substrate W is not present in the liquid processor 62, the control circuit 9 determines that the liquid processor 62 is capable of accommodating the substrate W. For example, if the substrate W is present in the liquid processor 62, the control circuit 9 determines that the liquid processor 62 is incapable of accommodating the substrate W.

If it is determined in step S122 that the liquid processor 62 is capable of accommodating the substrate W (“Yes” in step S122), the control circuit 9 proceeds to step S108. That is, if the liquid processor 62 is capable of accommodating the substrate W, the control circuit 9 changes transfer schedule so that the fourth transferrer 61 immediately transfers the substrate W from the substrate holder 70 to the liquid processor 62 without waiting for the predetermined standby time. In this case, it is easy to suppress the concavo-convex pattern of the substrate W from collapsing. The transfer schedule is a chronological arrangement of a transfer destination and transfer order of each substrate W.

If it is determined in step S122 that the liquid processor 62 is incapable of accommodating the substrate W (“No” in step S122), the control circuit 9 causes the substrate W to wait on the second delivery stage 54 until the liquid processor 62 becomes capable of accommodating the substrate W.

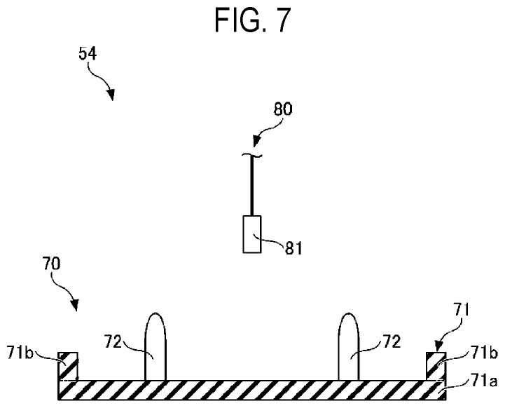

In step S108, as illustrated in FIG. 7, the fourth transferrer 61 unloads the substrate W supported by the three pins 72 from the second delivery stage 54, transfers the substrate W to the liquid processor 62, and ends the process.

As described above, according to the embodiment, the control circuit 9 determines whether the upper surface of the substrate W is lyophilic or lyophobic based on the first upper surface image captured by the image capturer 53b. If the upper surface of the substrate W is determined to be lyophobic, the pure water supply 80 does not supply pure water to the upper surface of the substrate W, and the fourth transferrer 61 transfers the substrate W from the substrate holder 70 to the liquid processor 62. In this case, when the fourth transferrer 61 transfers the substrate W from the substrate holder 70 to the liquid processor 62, the droplets are suppressed from falling from the upper surface of the substrate W, making it possible to reduce the maintenance frequency. Therefore, it is possible to suppress a decrease in the operation rate of the substrate processing system 1.

In addition, when the fourth transferrer 61 transfers the substrate W, the image capturer 61c may capture the upper surface of the substrate W being transferred by the fourth transfer arm 61b to acquire the second upper surface image, which is the image of the upper surface of the substrate W. The image capturer 61c may transmit the acquired second upper surface image to the control circuit 9. The control circuit 9 may determine whether the substrate W is tilted based on the second upper surface image and may change the operation of the fourth transferrer 61 according to the determination result. The operation of the fourth transferrer 61 includes, for example, a transfer speed of the fourth transferrer 61. The operation of the fourth transferrer 61 may include an entry height of the fourth transfer arm 61b when the fourth transferrer 61 transfers the substrate W to the liquid processor 62 by the fourth transfer arm 61b. In this case, it is possible to transfer the substrate W to a desired position of the liquid processor 62. For example, if the upper surface of the substrate W is lyophobic, even when the substrate W is not tilted while placed on the second delivery stage 54, the first liquid film LF1 on the upper surface of the substrate W may flow upon transfer of the substrate W by the fourth transferrer 61 and thus the substrate W may be tilted.

### Second Delivery Stage of Second Example

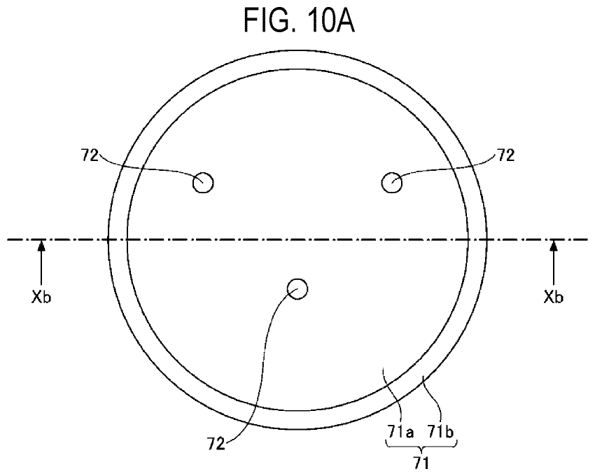

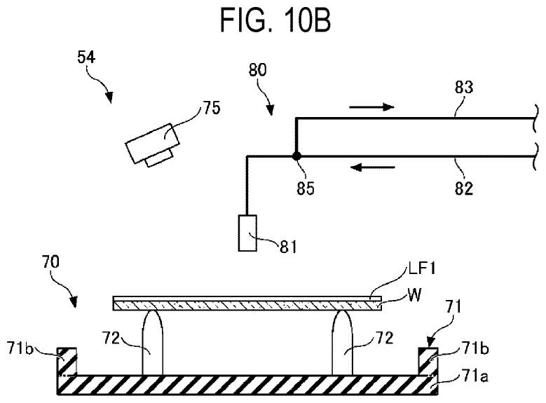

The second delivery stage 54 according to a second example is described with reference to FIGS. 10A and 10B. FIGS. 10A and 10B are diagrams illustrating the second delivery stage 54 according to the second example of an embodiment. FIG. 10A is a plane view, and FIG. 10B is a cross-sectional view. FIG. 10B is a cross-sectional view taken along line Xb-Xb in FIG. 10A. In FIG. 10A, the pure water supply 80 and an image capturer 75 are omitted.

As illustrated in FIG. 10B, the second delivery stage 54 may include the image capturer 75. The image capturer 75 is provided above the substrate holder 70. The image capturer 75 captures the upper surface of the substrate W supported by the pins 72 to acquire the first upper surface image, which is the image of the upper surface of the substrate W. The image capturer 75 captures the upper surface of the substrate W supported by the pins 72, for example, before the pure water supply 80 supplies pure water to the substrate W. The image capturer 75 transmits the acquired first upper surface image to the control circuit 9. The image capturer 75 includes the same configuration as, for example, the image capturer 53b. The control circuit 9 may perform control for determining whether the pure water supply 80 supplies pure water to the upper surface of the substrate W based on the first upper surface image acquired by the image capturer 75. The image capturer 75 is an example of the first image capturer.

### Second Delivery Stage of Third Example

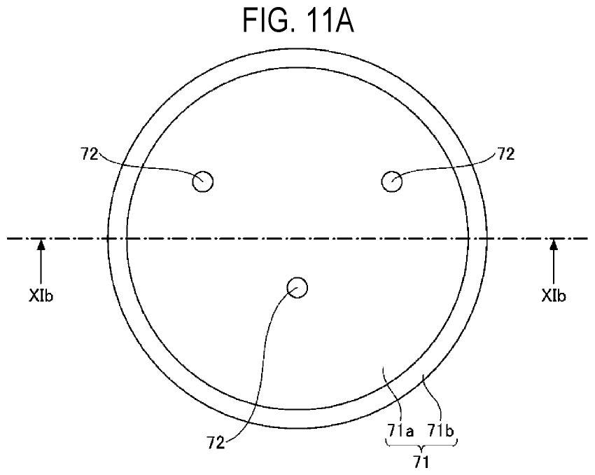

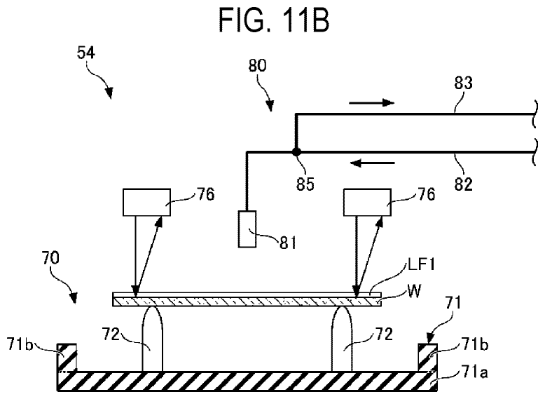

The second delivery stage 54 according to a third example is described with reference to FIGS. 11A and 11B. FIGS. 11A and 11B are diagrams illustrating the second delivery stage 54 according to the third example of an embodiment. FIG. 11A is a plane view, and FIG. 11B is a cross-sectional view. FIG. 11B is a cross-sectional view taken along line XIb-XIb in FIG. 11A. In FIG. 11A, the pure water supply 80 and laser displacement meters 76 are omitted.

As illustrated in FIG. 11B, the second delivery stage 54 may include the laser displacement meters 76. The laser displacement meters 76 are provided, for example, at a front position (position on the negative side of the X-axis) when the fourth transfer arm 61b enters and at an inner position (position on the positive side of the X-axis) when the fourth transfer arm 61b enters. Each laser displacement meter 76 is provided above the substrate holder 70. Each laser displacement meter 76 measures a height of the upper surface of the substrate W supported by the pins 72. Each laser displacement meter 76 measures the height of the upper surface of the substrate W supported by the pin 72, for example, after the pure water supply 80 supplies pure water to the substrate W. Each laser displacement meter 76 transmits the measured height of the upper surface of the substrate W to the control circuit 9. The control circuit 9 calculates a slope of the substrate W supported by the pins 72 based on the height of the upper surface of the substrate W measured by the two laser displacement meters 76. In the example of FIG. 11B, the number of laser displacement meters 76 is two but may be three or more. The laser displacement meter 76 is an example of a sensor.

The sensor may be an image capturer configured to be capable of capturing the substrate W supported by the pins 72. In this case, the control circuit 9 may calculate the slope of the substrate W supported by the pins 72 based on an image of the substrate W captured by the image capturer. The sensor may be a weight sensor built into each pin 72. In this case, the control circuit 9 may calculate the slope of the substrate W supported by the pins 72 by comparing weights measured by the weight sensors built into the respective pins 72.

### Slope Determination Control

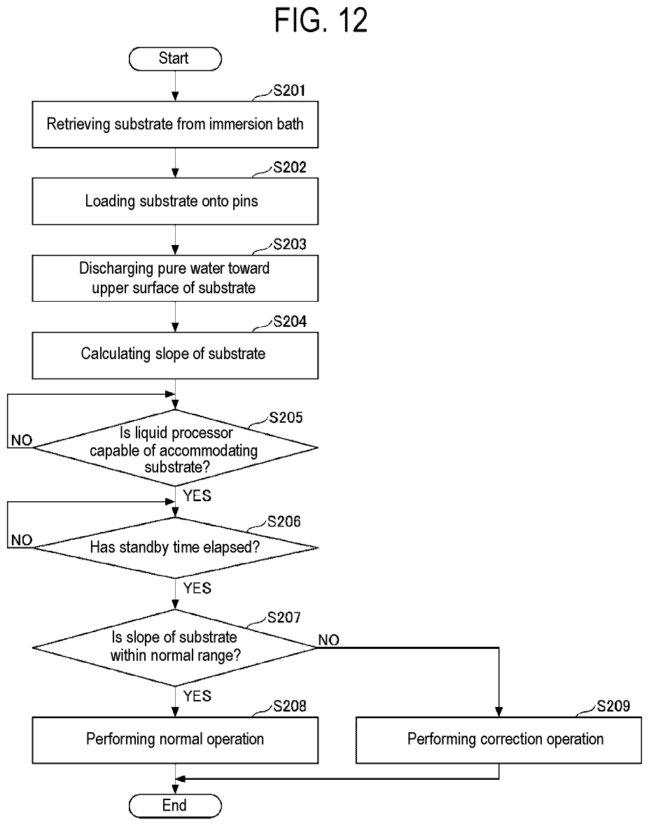

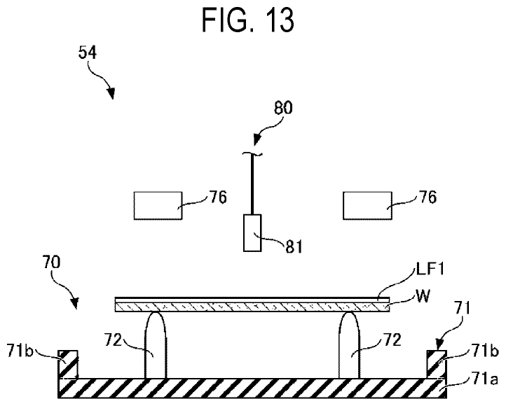

An example of control for changing the operation of the fourth transferrer 61 based on the slope of the substrate W supported by the pins 72 (hereinafter referred to as “slope determination control”) is described with reference to FIGS. 12 to 16. The slope determination control is performed when transferring the substrate W immersed in the immersion bath 51 of the second interface 5 to the single-wafer processor 6. FIG. 12 is a flowchart illustrating an example of the slope determination control. FIGS. 13 to 16 are cross-sectional views illustrating examples of the slope determination control. A process illustrated in FIG. 12 is performed under control of the control circuit 9.

In step S201, the third transferrer 53 retrieves the substrate W of the lot L held by the second transfer arm 52c from the second rinse liquid in the immersion bath 51.

In step S202, the third transferrer 53 transfers the substrate W to the second delivery stage 54 by the third transfer arm 53a, and, as illustrated in FIG. 13, loads the substrate W onto the three pins 72. In this case, the first liquid film LF1, which is the liquid film of the second rinse liquid, is formed on the upper surface of the substrate W.

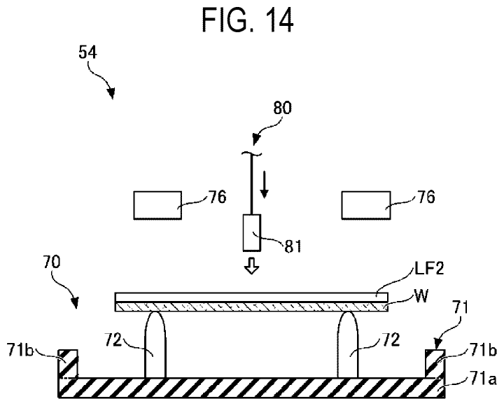

In step S203, as illustrated in FIG. 14, the nozzle 81 discharges pure water toward the upper surface of the substrate W. As a result, the second liquid film LF2, which is the liquid film of pure water, is formed on the upper surface of the substrate W. After the second liquid film LF2 is formed on the upper surface of the substrate W, the nozzle 81 stops discharging pure water onto the substrate W.

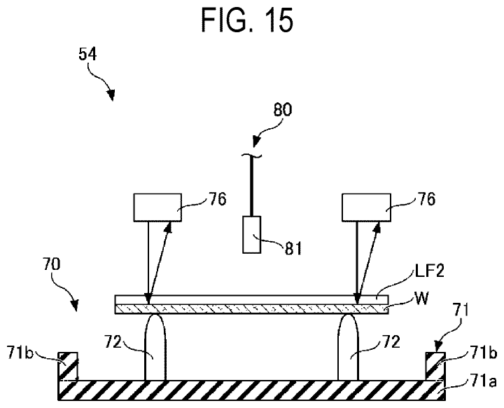

In step S204, as illustrated in FIG. 15, each laser displacement meter 76 measures the height of the upper surface of the substrate W supported by the three pins 72. Each laser displacement meter 76 transmits the measured height of the upper surface of the substrate W to the control circuit 9. The control circuit 9 calculates the slope of the substrate W supported by the pins 72 based on the height of the upper surface of the substrate W measured by the plurality of laser displacement meters 76.

In step S205, the control circuit 9 determines whether the liquid processor 62 is capable of accommodating the substrate W. For example, when the substrate W is not present in the liquid processor 62, the control circuit 9 determines that the liquid processor 62 is capable of accommodating the substrate W. For example, when the substrate W is present in the liquid processor 62, the control circuit 9 determines that the liquid processor 62 is incapable of accommodating the substrate W.

If it is determined in step S205 that the liquid processor 62 is capable of accommodating the substrate W (“Yes” in step S205), the control circuit 9 proceeds to step S206. If it is determined in step S205 that the liquid processor 62 is incapable of accommodating the substrate W (“No” in step S205), the control circuit 9 causes the substrate W to wait on the second delivery stage 54 until the liquid processor 62 becomes capable of accommodating the substrate W.

In step S206, the control circuit 9 determines whether a predetermined standby time has elapsed from the time when the substrate W is transferred to the second delivery stage 54. The predetermined standby time is set in advance by, for example, a processing recipe. The predetermined standby time may be 0 seconds. In other words, step S206 may be omitted.

In step S206, if it is determined that the predetermined standby time has elapsed (“Yes” in step S206), the control circuit 9 proceeds to step S207. If it is determined that the predetermined standby time has not elapsed (“No” in step S206), the control circuit 9 causes the substrate W to wait on the second delivery stage 54 until the predetermined standby time has elapsed.

In step S207, the control circuit 9 determines whether the slope of the substrate W calculated in step S204 is within a normal range. If it is determined that the slope of the substrate W is within the normal range in step S207 (“Yes” in step S207), the control circuit 9 proceeds to step S208. If it is determined that the slope of the substrate W is not within the normal range in step S207 (“No” in step S207), the control circuit 9 proceeds to step S209.

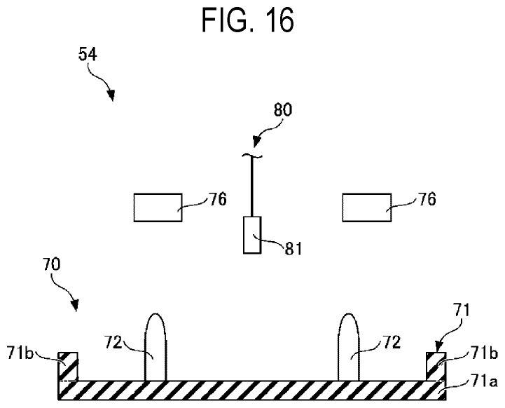

In step S208, the fourth transferrer 61 performs a normal operation and ends the process. The normal operation includes, as illustrated in FIG. 16, unloading, by the fourth transferrer 61, the substrate W supported by the three pins 72 from the second delivery stage 54 and transferring the substrate W to the liquid processor 62.

In step S209, the fourth transferrer 61 performs a correction operation and ends the process. The correction operation includes, for example, an operation in which the fourth transferrer 61 unloads the substrate W supported by the three pins 72 from the second delivery stage 54, in a state in which the entry height of the fourth transfer arm 61b is changed relative to the normal operation, and transfers the substrate W to the liquid processor 62. In this case, it is possible to prevent the fourth transfer arm 61b from coming in contact with the substrate W when the substrate W supported by the three pins 72 is tilted. This prevents damage to the substrate W. Therefore, it is possible to suppress a decrease in the operation rate of the substrate processing system 1. The correction operation may include an operation in which the fourth transferrer 61 unloads the substrate W supported by the three pins 72 from the second delivery stage 54, in a state in which the transfer speed of the substrate W by the fourth transfer arm 61b is changed to be slow compared to the normal operation, and transfers the substrate W to the liquid processor 62. The correction operation may include an operation in which the substrate W supported by the three pins 72 is stopped from being unloaded from the second delivery stage 54.

As described above, according to the embodiment, the control circuit 9 performs control for calculating the slope of the substrate W based on the height of the upper surface of the substrate W measured by the laser displacement meter 76 and control for changing the operation of the fourth transferrer 61 based on the calculated slope of the substrate W. In this case, when the substrate W supported by the three pins 72 is tilted, it is possible to prevent the fourth transfer arm 61b from contacting the substrate W. As a result, it is possible to prevent a damage to the substrate W. Therefore, it is possible to suppress a decrease in the operation rate of the substrate processing system 1.

In addition, when the fourth transferrer 61 transfers the substrate W, the image capturer 61c may capture the upper surface of the substrate W being transferred by the fourth transfer arm 61b to acquire the second upper surface image, which is the image of the upper surface of the substrate W. The image capturer 61c may transmit the acquired second upper surface image to the control circuit 9. The control circuit 9 may determine whether the substrate W is tilted based on the second upper surface image and may change the operation of the fourth transferrer 61 according to the determination result. The operation of the fourth transferrer 61 includes, for example, the transfer speed of the fourth transferrer 61. The operation of the fourth transferrer 61 may also include the entry height of the fourth transfer arm 61b when the fourth transferrer 61 transfers the substrate W to the liquid processor 62 by the fourth transfer arm 61b. In this case, it is possible to transfer the substrate W to a desired position of the liquid processor 62.

According to the present disclosure, it is possible to suppress a decrease in an operation rate of a substrate processing system.

While certain embodiments have been described, these embodiments have been presented by way of example only, and are not intended to limit the scope of the disclosure. Indeed, the embodiments described herein may be embodied in a variety of other forms. Furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A substrate processing system, comprising:
a batch processor configured to collectively process substrates;
a single-wafer processor configured to process the substrates one by one;
an interface configured to deliver the substrates from the batch processor to the single-wafer processor; and
a control circuit,
wherein the interface includes:
a substrate holder configured to hold a substrate among the substrates;
a processing liquid supply configured to supply a processing liquid, which suppresses drying of an upper surface of the substrate held by the substrate holder, to the upper surface of the substrate; and
an image capturer configured to capture the upper surface of the substrate, and
wherein the control circuit performs control for determining whether the processing liquid supply supplies the processing liquid to the upper surface of the substrate based on an image of the upper surface of the substrate captured by the image capturer.

2. The substrate processing system of claim 1, wherein the control circuit performs control for determining whether the upper surface of the substrate is lyophilic or lyophobic based on the image of the upper surface of the substrate captured by the image capturer, and
wherein the control circuit performs control for causing the processing liquid supply not to supply the processing liquid to the upper surface of the substrate upon determining that the upper surface of the substrate is lyophobic.

3. The substrate processing system of claim 2, wherein the control circuit performs control for causing the processing liquid supply to supply the processing liquid to the upper surface of the substrate upon determining that the upper surface of the substrate is lyophilic.

4. The substrate processing system of claim 3, wherein the processing liquid is pure water.

5. The substrate processing system of claim 2, wherein the control circuit performs control for determining whether the upper surface of the substrate is lyophilic or lyophobic with respect to the processing liquid based on a ratio of an area covered by the processing liquid to an entire area of the upper surface of the substrate in the image of the upper surface of the substrate captured by the image capturer.

6. The substrate processing system of claim 1, wherein the control circuit performs control for causing the image capturer to capture the upper surface of the substrate before the substrate is held by the substrate holder.

7. The substrate processing system of claim 1, wherein the control circuit performs control for causing the image capturer to capture the upper surface of the substrate held by the substrate holder.

8. The substrate processing system of claim 1, wherein the processing liquid is pure water.

9. A substrate processing system, comprising:
a batch processor configured to collectively process substrates;
a single-wafer processor configured to process the substrates one by one;
an interface configured to deliver the substrates from the batch processor to the single-wafer processor; and
a control circuit,
wherein the interface includes:
a substrate holder configured to hold a substrate among the substrates;
a processing liquid supply configured to supply a processing liquid, which suppresses drying of an upper surface of the substrate held by the substrate holder, to the upper surface of the substrate; and
a sensor configured to sense a state of the substrate held by the substrate holder,
wherein the single-wafer processor includes a transferrer configured to retrieve the substrate from the substrate holder, and
wherein the control circuit performs:
control for calculating a slope of the substrate based on the state of the substrate measured by the sensor; and
control for changing an operation of the transferrer based on the calculated slope of the substrate.

10. The substrate processing system of claim 9, wherein the control circuit performs control for causing the sensor to measure the state of the substrate to which the processing liquid has been supplied.

11. The substrate processing system of claim 10, wherein the processing liquid is pure water.

12. The substrate processing system of claim 9, wherein the operation of the transferrer includes an entry height of a transfer arm when the transferrer receives the substrate by the transfer arm.

13. The substrate processing system of claim 9, wherein the operation of the transferrer includes a transfer speed of the transferrer.

14. The substrate processing system of claim 9, wherein the processing liquid is pure water.
